(19) United States
(12) Patent Application Publication
(10) Pub. No.: US 2026/0233663 A1
(43) Pub. Date: Aug. 13, 2026

(54) Ring Block

(71) Applicant: pewag austria GmbH, Kapfenberg (AT)

(72) Inventor: Ranko Ivanic, Bruck an der Mur (AT)

(73) Assignee: pewag austria GmbH, Kapfenberg (AT)

(21) Appl. No.: 19/448,665

(22) Filed: Jan. 14, 2026

(30) Foreign Application Priority Data
Feb. 12, 2025 (EP) 25157647.6

(51) Int. Cl. B60P 7/08; B66C 1/66

(52) U.S. Cl. CPC B60P 7/0807; B66C 1/66

(57) ABSTRACT

A ring bracket includes a ring lug having first and second retaining element, and first and second mounting brackets for supporting the ring lug about a pivot axis. The mounting brackets each have a retaining bearing for the retaining elements. The first retaining element has a retaining lug and the first mounting bracket has a guide groove corresponding to the retaining lug of the first retaining element, so that in an insertion position, the first retaining element can be inserted into the retaining bearing, so that the ring lug can be brought into an inserted state. In the inserted position, the ring lug can be transferred into a mounting position by pivoting the ring lug about the pivot axis. When transferring the ring lug from the inserted state to the mounting position, the retaining lug engages in the guide groove of the first mounting bracket.

### BACKGROUND OF THE INVENTION

### Field of the Invention

The invention relates to a ring block for attaching, lifting, and/or lashing loads, wherein the ring block comprises:
a ring lug for securing loads, which ring lug comprises a first retaining element and a second retaining element, which extend from the ring lug in opposite directions along a common pivot axis, and
a first mounting bracket and a second mounting bracket for supporting the ring lug about the pivot axis, wherein the mounting brackets can be fastened to a load, and wherein the mounting brackets each have a retaining bearing for the retaining elements of the ring lug can be pivotally mounted about the pivot axis.

The invention also relates to a method for assembling a ring block according to the invention.

### Description of the Related Art

In the field of lifting technology, weldable attachment points, in particular so-called ring blocks, are essential components for the safe lifting and transport of heavy loads. The prior art comprises various solutions in which the ring is mounted in a holder to ensure a certain degree of mobility. However, known systems have several disadvantages. For example, many designs require separate securing elements to hold the ring in position, which increases the assembly effort and requires additional components. This can not only increase manufacturing costs, but also introduce potential weak points in the form of wear or play in the securing mechanism. In addition, conventional securing systems can fail or come loose under high loads, compromising the safety of the application.

DE 102009040524 A1 describes a ring block for attaching, lifting, and/or lashing loads, which comprises a ring lug and fastening blocks. However, mounting the ring lug in the fastening blocks requires separate fastening elements or additional securing elements (fastening pins that can be inserted into specially shaped partial volumes) to secure the ring lug against axial movement along the pivot axis. This can lead to increased installation effort and make handling more difficult. There is also a risk that these separate securing elements may become loose or lost over time, which can compromise operational safety.

### SUMMARY OF THE INVENTION

### Object of the Invention

The present invention therefore has the object of providing a ring block that enables simplified assembly without the need for separate securing elements or additional fastening parts. In addition, the axial securing of the ring lug in the mounting bracket should be ensured in a simple and reliable manner.

### Solution of the Object

To achieve this object the first retaining element of the ring lug has a retaining lug which extends radially to the pivot axis from the first retaining element, and wherein the first mounting bracket comprises a guide groove which corresponds to the retaining lug of the first retaining element in such a way that in an insertion position of the ring lug, the first retaining element with the retaining lug can be inserted into the retaining bearing of the first mounting bracket so that the ring lug can be brought into an inserted state in the retaining bearing, wherein, in the inserted state of the ring lug in the retaining bearing, the ring lug can be transferred into a mounting position by pivoting the ring lug about the pivot axis, wherein, when the ring lug is moved from the inserted state into the mounting position, the retaining lug engages in the guide groove of the first mounting bracket in such a way that the retaining lug can be guided in the guide groove, so that the guide groove in combination with the retaining lug in the mounting position of the ring lug secures the ring lug against movement along the pivot axis.

The ring block according to the invention comprises a ring lug provided with retaining elements extending along a common pivot axis. A retaining lug on at least one retaining element engages in a corresponding guide groove of a mounting bracket. This allows the ring lug to be mounted in an insertion position and then secured in a mounting position by a simple pivoting movement.

This automatically secures the ring lug against axial movement along the pivot axis without the need for additional fastening elements. This design facilitates installation, reduces installation effort, and increases operational safety, as no separate securing elements are required that could come loose or be lost.

By eliminating the need for separate fastening or securing elements for axial fixation of the ring lug, the design is simplified and the installation effort is reduced. The use of the retaining lug and the guide groove enables particularly time-efficient and uncomplicated installation. In addition, operational safety is increased by an integrated securing function, as there are no loose parts that could come loose or be lost. This also reduces maintenance requirements, as no additional components need to be replaced or readjusted.

Another advantage of the retaining lug design is that the first mounting bracket can be completely attached to the load, in particular welded, before the ring lug and the second mounting bracket are attached. This gives the welder optimal access to the welding site without being hindered in any way by the ring lug, in cases where the mounting brackets are welded on. It also makes it easier to clean the welding site on the first mounting bracket.

The load to which the mounting brackets of the ring block are attached can have various shapes and applications. These include, in particular, steel girders or steel structures, such as those used in the construction industry or in mechanical engineering to safely lift or secure heavy loads. They can also be transport and lifting devices such as containers, lifting frames, or assembly platforms, where the ring block is mounted for lifting and lashing loads. Other areas of application include ship hulls or offshore structures, where the ring block is used to secure loads, as well as machine housings or frames that enable safe handling in industrial plants.

In addition, it is suitable for attachment to vehicles or trailers to secure heavy loads during transport. Concrete foundations or concrete beams can also serve as a mounting base, for example for temporary lifting points in the construction industry. Finally, the ring block can also be attached to crane girders or load-bearing equipment to ensure safe load handling with crane systems or other lifting systems. Depending on the application, the goods can be made of different materials, with the fastening method-for example, welding or screwing-being adapted accordingly.

It may be provided that the first and/or second mounting bracket can be fastened to the load by welding. This ensures increased stability and durability of the connection, as welded mounting brackets do not require additional connecting elements such as screws or bolts, which could loosen over time.

It may be provided that the second retaining element comprises a retaining lug which extends from the second retaining element radially to the pivot axis. This enables additional axial securing, which ensures even more robust fastening of the ring lug and makes assembly more symmetrical, which facilitates handling.

It may be provided that the second mounting bracket has a guide groove which corresponds to the retaining lug of the second retaining element. This enables improved load distribution and additional guidance of the ring lug, which increases the load-bearing capacity of the system and improves safety.

It may be provided that the guide groove of the first mounting bracket comprises an engagement section and a securing section, wherein a width of the guide groove tapers from the engagement section toward the securing section, wherein the width of the securing section corresponds to the retaining lug of the first retaining element in such a way that, when the ring lug is in the mounting position, the retaining lug of the first retaining element, upon engagement with the securing section, cooperates with the securing section such that the ring lug is secured against movement along the pivot axis. The width of the guide groove in the securing section corresponds to the width of the retaining lug so that there is no or little play along the pivot axis, so that the ring lug as a whole is secured against movement along the pivot axis when the ring lug is in the mounting position in the first mounting bracket.

It may be provided that the guide groove of the second mounting bracket has an engagement section and a securing section, wherein a width of the guide groove tapers from the engagement section toward the securing section, wherein the width of the securing section corresponds to the retaining lug of the second retaining element in such a way that, when the ring lug is in the mounting position, the retaining lug of the second retaining element, upon engagement with the securing section, cooperates with the securing section such that the ring lug is secured against movement along the pivot axis.

It may be provided that the ring lug has at least one spacer element on which the ring lug rests in the mounting position so that the retaining elements do not rest on a surface of the loads. A further advantage is the design of the ring lug with spacer studs, which ensure that the retaining lug rests securely in the receiving groove without jamming in the guide groove when pivoting around the pivot axis when the ring lug is moved into the mounting position. At the same time, the spacer studs lift the ring lug as far as possible from the load in the mounting position, ensuring that the second mounting bracket can also be securely fastened near the second retaining element. Without the spacer studs, the retaining elements of the ring lug would rest on the surface of the load to which the ring bracket is to be fastened. may be provided that the ring lug is integrally manufactured with the retaining elements from a single material.

It may be provided that the ring lug and the mounting brackets are made of metal.

The object is also achieved by a method for mounting a ring bracket according to the invention, wherein the method comprises the following steps in chronological order:
a) fastening the first mounting bracket to a load;
b) bringing the ring lug into the insertion position;
c) inserting the ring lug into an inserted state of the ring lug in the retaining bearing of the first mounting bracket;
d) transferring the ring lug from the inserted state to a mounting position in the retaining bearing of the first mounting bracket by pivoting the ring lug about the pivot axis so that the ring lug is secured against movement along the pivot axis in the first mounting bracket;
e) applying the second mounting bracket to the second retaining element of the ring lug so that the second retaining element is positioned in the retaining bearing of the second mounting bracket;

### f) fastening the second mounting bracket to the load.

After welding on the first mounting bracket, the ring lug is inserted into the first mounting bracket, for example with the retaining lug facing downwards. By tilting or swiveling the ring lug, the retaining lug threads into the guide groove of the first mounting bracket and is fixed axially. The second mounting bracket is then placed on the retaining lug of the ring lug, which is now, for example, at the top, whereby it is also fixed axially and can be fastened. may be provided that in step a) the first mounting bracket is attached to the load by welding.

It may be provided that in step f) the second mounting bracket is attached to the load by welding.

### BRIEF DESCRIPTION OF THE FIGURES

The invention is explained in more detail below with reference to exemplary drawings. Here,

FIG. 1A shows an exemplary ring block in a front view, comprising a ring lug with a first and second retaining element, which ring lug is mounted in a first and second mounting bracket by means of the first and second retaining elements so as to be pivotable about a pivot axis;

FIG. 1B shows the exemplary ring block from FIG. 1 in a side view;

FIG. 2 shows the exemplary ring block from FIG. 1 in an exploded view, showing the first and second retaining elements and the retaining lugs arranged on them;

FIG. 3A shows the first and second mounting brackets in a first view;

FIG. 3B shows the first and second mounting brackets in a section A-A from FIG. 3A, showing a guide groove with different widths, with the guide groove corresponding to the retaining lugs of the retaining elements;

FIG. 3C shows the first and second mounting brackets in a view from below;

FIG. 4A the exemplary ring block from FIG. 1, wherein the ring lug is in an inserted state in the first mounting bracket;

FIG. 4B the ring lug in an intermediate position before a mounting position can be reached, wherein the retaining lug engages an engagement section of the guide groove;

FIG. 4C the ring lug in the mounting position, wherein the retaining lug engages the securing section of the guide groove, thereby securing the ring lug against movement along the pivot axis;

FIG. 5A the first mounting bracket secured to a load and the ring lug in an insertion position;

FIG. 5B-5C the ring lug in an inserted state in the first mounting bracket;

FIG. 5D the ring lug in the mounting position; and

FIG. 5E the assembled ring block, wherein the second mounting bracket is placed on the ring lug and secured to the load.

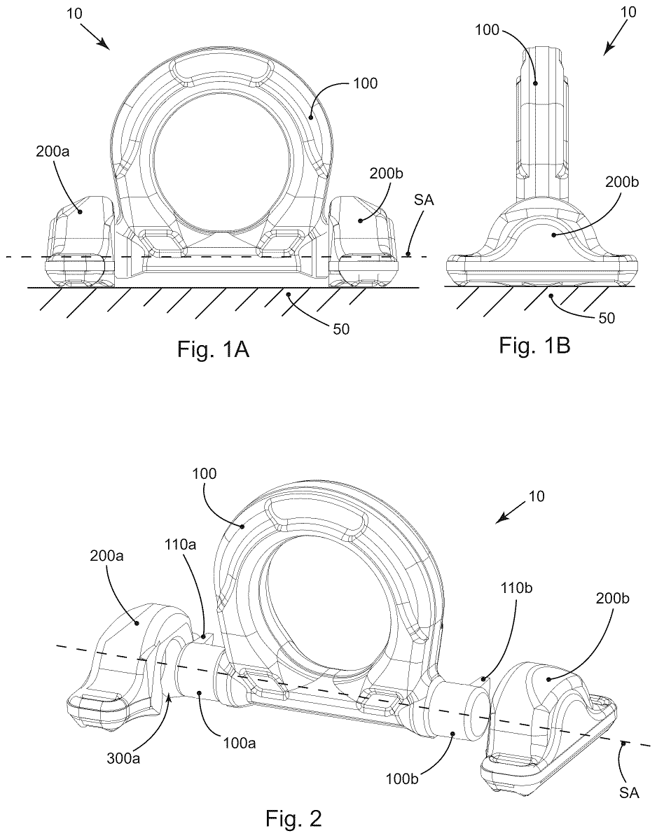

FIG. 1 shows an exemplary ring block 10 for slinging, lifting, and/or lashing loads in a front view, wherein the ring block 10 comprises a ring lug 100 for securing loads. FIG. 2 shows the ring block 10 from FIG. 1 in a side view.

The ring lug 100 has a first retaining element 100a and a second retaining element 100b, which extend from the ring lug 100 in opposite directions along a common pivot axis SA, wherein the ring lug 100 with the retaining elements 100a, 100b is made in one piece from a single material.

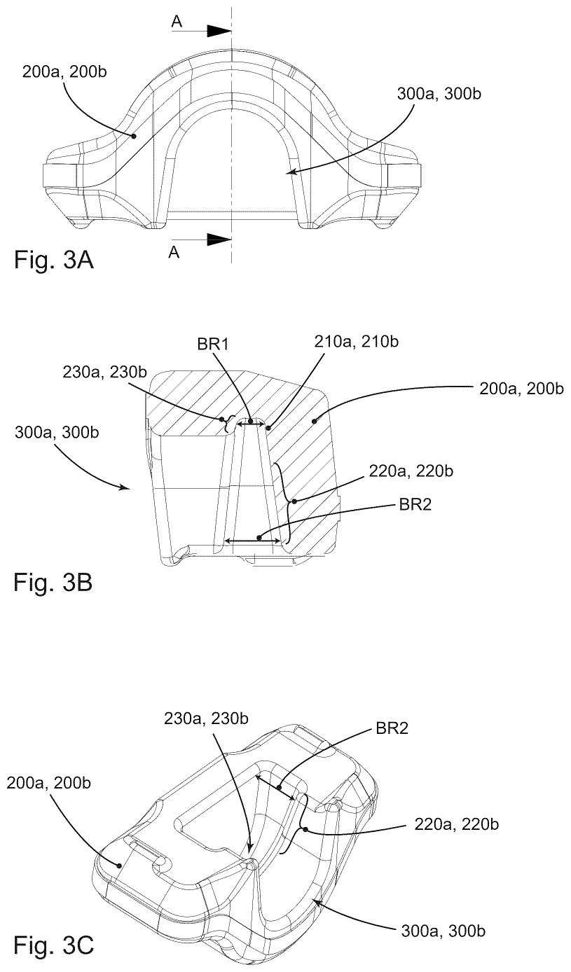

Furthermore, the ring bracket 10 comprises a first mounting bracket 200a and a second mounting bracket 200b for supporting the ring bracket 100 about the pivot axis SA, wherein the mounting brackets 200a, 200b can be attached to a load 50, in particular by means of welding. The fastening blocks 200a, 200b each have a retaining bearing 300a, 300b for the retaining elements 100a, 100b of the ring lug 100, which can pivot about the pivot axis SA. The retaining bearings 300a, 300b are more clearly visible in FIG. 2 and FIG. 3A to FIG. 3C. In the example shown, the ring strap 100 and the mounting brackets 200a, 200b are made of metal.

As can be seen in FIG. 2, for example, the first retaining element 100a of the ring lug 100 has a retaining lug 110a which extends radially from the first retaining element 100a to the pivot axis SA. In the example shown, the second retaining element 100b also has a retaining lug 110b which extends radially from the second retaining element 100b to the pivot axis SA.

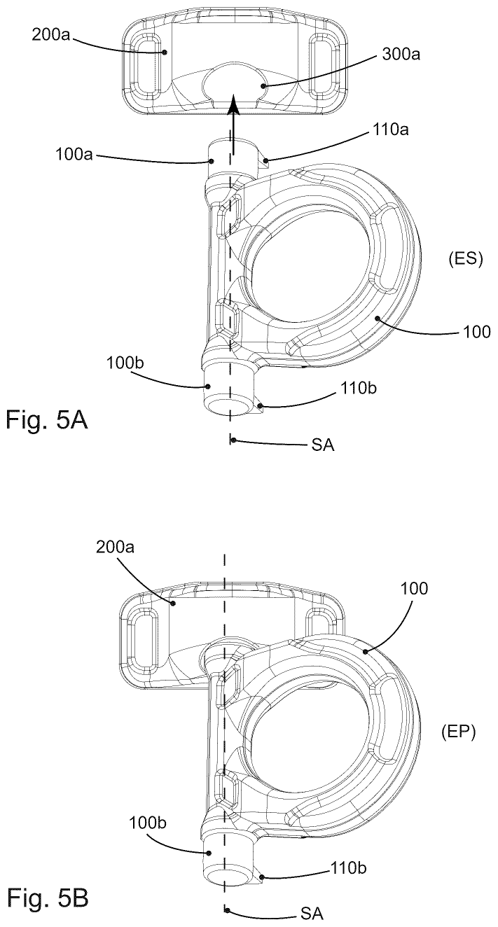

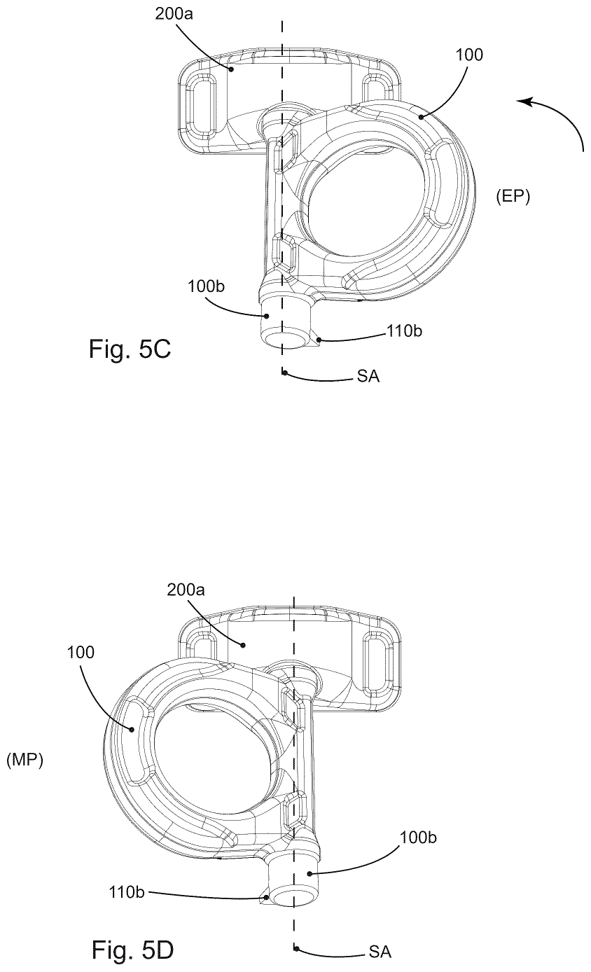

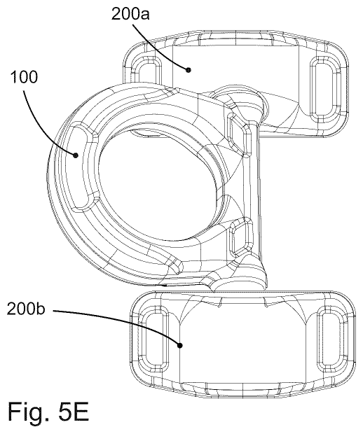

Furthermore, the first mounting bracket 200a comprises a guide groove 210a, which corresponds to the retaining lug 110a of the first retaining element 100a in such a way that, in an insertion position ES of the ring lug 100, which insertion position ES is shown, for example, in FIG. 5A, the first retaining element 100a with the retaining lug 110a can be inserted into the retaining bearing 300a of the first mounting block 200a, so that the ring lug 100 can be brought into an inserted state EP in the retaining bearing 300a, wherein in the inserted state EP of the ring lug 100, as shown in FIG. 5B and FIG. 5C, the retaining lug 100 can be transferred from the inserted state EP in the retaining bearing 300a to a mounting position MP by pivoting the ring lug 100 about the pivot axis SA, as shown in FIG. 5D.

When transferring the ring lug 100 from the inserted position EP to the mounting position MP, the retaining lug 110a engages in the guide groove 210a of the first mounting bracket 200a in such a way that the retaining lug 110a can be guided in the guide groove 210a, so that the guide groove 210a in combination with the retaining lug 110a in the mounting position MP of the ring lug 100 secures the ring lug 100 against movement along the pivot axis SA.

The same principle applies to the retaining lug 110b of the second retaining element 100b with the second mounting bracket 200b, which also has a guide groove 210b.

In FIG. 3A to FIG. 3C, the first mounting bracket 200a can be seen, whereby the second mounting bracket 200b is identical in construction to the first mounting bracket 200a and can therefore also be seen in FIGS. 3A to 3C, whereby the structure shown and the following explanations apply to the second mounting bracket 200b. The guide groove 210a of the first mounting bracket 100a has an engagement section 220a and a securing section 230a, wherein a width BR1, BR2 of the guide groove 210a tapers from the engagement section 220a to the securing section 230a, wherein the width BR1 of the securing section 230a corresponds to the retaining lug 110a of the first retaining element 100a in such a way that when the ring tab 100 is in the mounting position MP, the retaining lug 110a of the first retaining element 100a, when engaged in the securing section 230a, interacts with the securing section 230a in such a way that the ring lug 100 is secured against movement along the pivot axis SA.

As already stated, the second mounting bracket 200b is constructed identically to the first mounting bracket 200a. For the sake of completeness, however, it should be noted that the guide groove 210b of the second mounting bracket 100b has an engagement section 220b and a securing section 230b, wherein a width BR1, BR2 of the guide groove 210b tapers from the engagement section 220b to the securing section 230b, wherein the width BR1 of the securing section 230b corresponds to the retaining lug 110b of the second retaining element 100b in such a way that when the ring lug 100 is in the mounting position MP, the retaining lug 110b of the second retaining element 100b, when engaged in the securing section 230b, interacts with the securing section 230b in such a way that the ring lug 100 is secured against movement along the pivot axis SA.

Furthermore, the ring lug 100 may have at least one spacer element on which the ring tab 100 rests in the mounting position MP, although this is not shown in the figures.

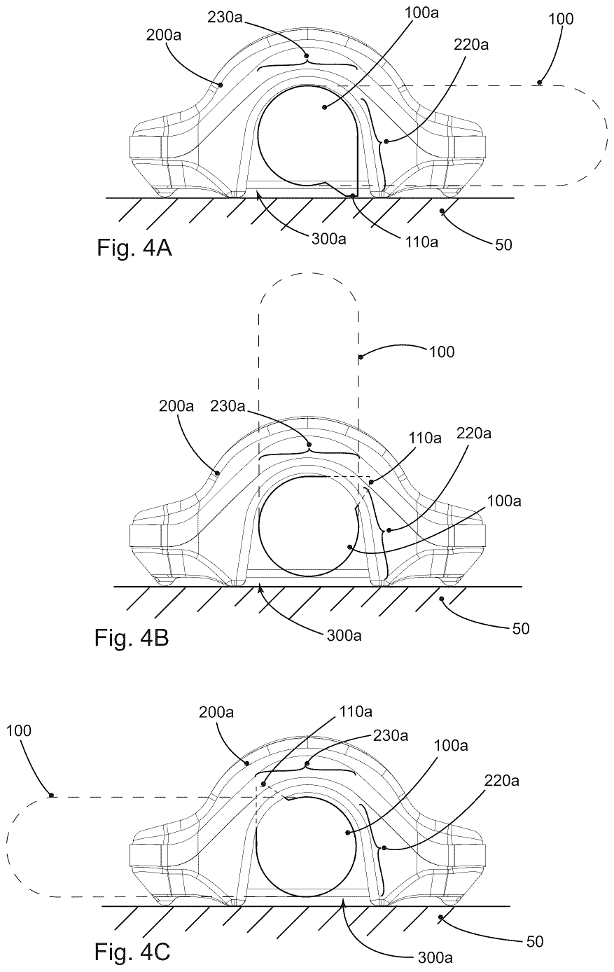

FIGS. 4A to 4C show the transfer of the ring lug from the inserted state EP to the mounting position MP. The ring tab 100 is shown in dashed lines. FIG. 4A shows inserted state EP of the ring tab 100, wherein the first retaining element 100a with the retaining lug 110a arranged thereon is inserted into the retaining bearing 300a. The ring tab 100 had to be moved into the insertion position ES beforehand, with the retaining lug 110a pointing downwards so that the first retaining element 100a can be inserted completely into the retaining bearing 300a, thereby allowing the ring lug 100 to be moved into the inserted state EP.

By pivoting the ring lug 100 about the pivot axis SA (counterclockwise in the example shown), the retaining lug 110a engages the engagement section 220a of the guide groove 210a and is guided by the guide groove 210a as it continues to pivot, as shown in FIG. 4B.

By further pivoting the ring tab 100 into the mounting position MP, the retaining lug 110a engages the securing section 230a of the guide groove 210a, thereby securing the ring tab 100 against movement along the pivot axis, as shown in FIG. 4C. Securing is achieved by the width BR1 of the securing section 230a of the guide groove 210a essentially corresponding to the width of the retaining lug 110a, so that there is no play for the retaining lug 110a along a movement of the pivot axis SA.

The same principle also applies to the retaining lug 110b of the second retaining element 100b with the second mounting bracket 200b, which also has a guide groove 210b.

FIG. 5A to FIG. 5E also show a method for mounting the ring block 10 as described above, wherein in a first step a) the first mounting block 200a is attached to the load 50, in particular by welding.

In the next step b), the ring lug 100 is moved into the insertion position ES, as shown in FIG. 5A. Then, in step c), the ring lug 100 is inserted into the inserted state EP of the ring lug 100 in the retaining bearing 300a of the first mounting bracket 200a, as shown in FIG. 5B. Then, in step d), the ring lug 100 is transferred from the inserted state EP to a mounting position MP in the retaining bearing 300a of the first mounting bracket 200a by pivoting the ring lug 100 about the pivot axis SA, as indicated by an arrow in FIG. 5C, so that the ring lug 100 is secured against movement along the pivot axis SA in the first mounting bracket 200a when the ring lug 100 has reached the mounting position, as shown in FIG. 5D. The ring lug 100 rotates around the pivot axis SA by approximately 180° in the process.

In a next step e), the second mounting bracket 200b is applied to the second retaining element 100b of the ring lug 100 so that the second retaining element 100b is positioned in the retaining bearing 300b of the second mounting bracket 200b, as shown in FIG. 5E. The second mounting bracket 200b is placed on top of the ring lug 100.

In the next step f), the second mounting bracket 200b is attached to the load 50, in particular by welding.

1. A ring block for attaching, lifting, and/or lashing loads, wherein the ring block comprises:
a ring lug for securing loads, wherein the ring lug comprises a first retaining element and a second retaining element wherein the first and second retaining elements extend from the ring lug in opposite directions along a common pivot axis, and
a first mounting bracket and a second mounting bracket for supporting the ring lug about the pivot axis, wherein the mounting brackets can be fastened to a load, and wherein the mounting brackets each have a retaining bearing for the retaining elements of the ring lug can be pivotally mounted about the pivot axis,
characterized in that
the first retaining element of the ring lug has a retaining lug which extends radially to the pivot axis from the first retaining element,
and wherein the first mounting bracket comprises a guide groove which corresponds to the retaining lug of the first retaining element in such a way that in an insertion position of the ring lug, the first retaining element with the retaining lug can be inserted into the retaining bearing of the first mounting bracket so that the ring lug can be brought into an inserted state in the retaining bearing, wherein, in the inserted state of the ring lug in the retaining bearing, the ring lug can be transferred into a mounting position by pivoting the ring lug about the pivot axis, wherein, when the ring lug is moved from the inserted state into the mounting position, the retaining lug engages in the guide groove of the first mounting bracket in such a way that the retaining lug can be guided in the guide groove, so that the guide groove in combination with the retaining lug in the mounting position of the ring lug secures the ring lug against movement along the pivot axis.

2. The ring block according to claim 1, wherein the first and second mounting bracket can be fastened to the load by welding.

3. The ring block according to claim 1, wherein the second retaining element comprises a retaining lug extending from the second retaining element radially to the pivot axis.

4. The ring block according to claim 3, wherein the second mounting bracket has a guide groove corresponding to the retaining lug of the second retaining element.

5. The ring block according to claim 1, wherein the guide groove of the first mounting bracket comprises an engagement section and a securing, wherein a width of the guide groove tapers from the engagement section toward the securing section, wherein the width of the securing section corresponds to the retaining lug of the first retaining element such that, when the ring lug is in the mounting position, the retaining lug of the first retaining element, upon engagement with the securing section, cooperates with the securing section such that the ring lug is secured against movement along the pivot axis.

6. The ring block according to claim 1, wherein the guide groove of the second mounting bracket has an engagement section and a securing section, wherein a width of the guide groove tapers from the engagement section toward the securing section, wherein the width of the securing section corresponds to the retaining lug of the second retaining element in such a way that, when the ring lug is in the mounting position, the retaining lug of the second retaining element, upon engagement with the securing section, cooperates with the securing section such that the ring lug is secured against movement along the pivot axis.

7. The ring block according to claim 1, wherein the ring lug is integrally manufactured with the retaining elements from a single material.

8. The ring block according to claim 1, wherein the ring lug has at least one spacer element on which the ring lug rests in the mounting position.

9. A method for mounting a ring block according to any one of the preceding claims on a load, wherein the method comprises the following steps in chronological order:
a) fastening the first mounting bracket to a load;
b) bringing the ring lug into the insertion position;
c) inserting the ring lug into an inserted state of the ring lug in the retaining bearing of the first mounting bracket;
d) transferring the ring lug from the inserted state to a mounting position in the retaining bearing of the first mounting bracket by pivoting the ring lug about the pivot axis so that the ring lug is secured against movement along the pivot axis in the first mounting bracket;
e) applying the second mounting bracket to the second retaining element of the ring lug so that the second retaining element is positioned in the retaining bearing of the second mounting bracket; and
f) fastening the second mounting bracket to the load.

10. The method according to claim 9, wherein in step a) the first mounting bracket fastened to the load by welding.

11. The method according to claim 8, wherein in step f) the second mounting bracket is attached to the load by welding.
